(19) United States
(12) Patent Application Publication
(10) Pub. No.: US 2010/0069538 A1
(43) Pub. Date: Mar. 18, 2010

(54) Olefin Compositions with Enhanced Adhesion and Light Stability

(75) Inventor: Michael D. Kempe, Littleton, CO (US)

Correspondence Address: PAUL J WHITE, PATENT COUNSEL;NATIONAL RENEWABLE ENERGY LABORATORY (NREL), 1617 COLE BOULEVARD, MS 1734, GOLDEN, CO, 80401-3393, US

(73) Assignee: ALLIANCE FOR SUSTAINABLE ENERGY, LLC, Golden, CO (US)

(21) Appl. No.: 12/562,084

(22) Filed: Sep. 17, 2009

Related U.S. Application Data
(60) Provisional application No. 61/098,046, filed on Sep. 18, 2008.

(51) Int. Cl. C08L 23/18; C08L 23/12; C08L 23/06; C08K 5/3475; C08K 5/54

(52) U.S. Cl. 524/91; 524/579; 524/582; 524/585; 524/502; 524/261

(57) ABSTRACT

An olefin-based composition including a base resin including a copolymer including one or more α-olefins; one or more light stabilizers and one or more adhesion promoters. An olefin-based composition hereof may be used as an encapsulant in photovoltaic cells.

### CROSS-REFERENCE TO RELATED APPLICATIONS

The present application claims priority from the U.S. Provisional Application No. 61/098,496, filed 19 Sep. 2008; the subject matter of which hereby is specifically incorporated herein by reference for all that it discloses and teaches.

### CONTRACTUAL ORIGIN

The United States Government has rights in this invention under Contract No. DE-AC36-08GO28308 between the United States Department of Energy and the National Renewable Energy Laboratory, managed and operated by the Alliance for Sustainable Energy, LLC.

### BACKGROUND

Polymer structural materials are often sought having a variety of discrete characteristics. Alpha olefins, for example, might be sought in some circumstances as structural materials for their relatively low molecular weight, providing a soft rubbery quality, and often at low expense. Other characteristics, not inherent to alpha olefins or like materials might, if provided, expand the utility thereof. Good adhesion and/or stability in light exposure are two such characteristics. If provided, then such olefins may prove useful, inter alia, as encapsulants in photovoltaics. In or as part of photovoltaic (PV) cells and/or modules, an encapsulant is often used for one or more purposes. A primary purpose of such an encapsulant may be to bond, or laminate, multiple layers of a PV module together. Additional desirable encapsulant characteristics may include one or more of high optical transmittance, good adhesion to different module materials, mechanical compliance adequate to accommodate stresses induced by thermal expansion or other physical affect, and good dielectric properties such as electrical insulation. Stability to light is also desirable. Although a variety of encapsulant materials have been used in/on PV modules including for example, polyvinyl butyraldehyde, ethylene/acrylic acid based ionomers, thermoplastic polyurethanes and silicone rubber, inter alia, ethylene-vinyl-acetate (EVA) has more recently been an encapsulant of choice. Even so, challenges remain in providing good adhesion qualities, providing stability to light and ultraviolet exposure, as well as, for example, reducing un-wanted by-product production (e.g., acetic acid); providing less polar, better corrosion protection; reducing glass transition temperature; reducing dependence upon additional layers (e.g., PET film) to pass IEC electrical insulation tests; and/or reducing variation of mechanical moduli as a function of temperature.

### SUMMARY

The following implementations and aspects thereof are described and illustrated in conjunction with systems, tools and methods which are meant to be exemplary and illustrative, not limiting in scope. In various implementations, one or more of the above-described issues have been reduced or eliminated, while other implementations are directed to other improvements.

An exemplary olefin-based composition includes a base resin including a copolymer including an alpha-olefin (also referred to as α-olefin, or α-olefins herein), one or more light stabilizers, and one or more adhesion promoters. These α-olefins may include ethylene, propylene, octene or butene or combinations of two or more α-olefins. A metallocene type catalyst may also be used for polymerizing the alpha-olefin. The copolymer components may include a wider variety of alpha-olefinic monomers in a variety of combinations and ratios. The compositions hereof are otherwise as shown and described herein.

The foregoing specific aspects and advantages of the present developments are illustrative of those which can be achieved by these developments and are not intended to be exhaustive or limiting of the possible advantages which can be realized. Thus, those and other aspects and advantages of these developments will be apparent from the description herein or can be learned from practicing the disclosure hereof, both as embodied herein or as modified in view of any variations which may be apparent to those skilled in the art. Thus, in addition to the exemplary aspects and embodiments described above, further aspects and embodiments will become apparent by reference to and by study of the following descriptions.

### BRIEF DESCRIPTION OF THE DRAWINGS

Exemplary implementations are illustrated in referenced figures of the drawings. It is intended that the embodiments and figures disclosed herein are to be considered illustrative rather than limiting. In the drawings:

FIG. 1 is a graphical depiction of exemplary storage modulus and phase angle of EVA compared to compositions hereof.

FIG. 2 is a graphical depiction of an exemplary comparison of lap shear results after exposure.

FIG. 3 is a graphical depiction of exemplary phase angle measured using dynamic mechanical analysis.

FIG. 4 is a flowchart of an exemplary method.

FIG. 5 is an exemplary device made with a composition hereof.

### DESCRIPTION

Exemplary embodiments described herein include formulation details for olefin compositions having good adhesion and light stability. Such a composition may be useful in photovoltaics (PV), as for example, an encapsulant. As such, it may be useful as an encapsulant; particularly as a transparent polymer to replace ethylene-vinyl acetate (EVA) as an encapsulant. Such may thus be particularly useful in or on photovoltaic (PV) cells or modules. Exemplary formulations may prove advantageous over EVA because the present formulations may provide enhanced light stability, good adhesion, and may also provide one or more of the following: formulations may not produce acetic acid as a by-product, formulations are less polar than EVA thereby creating better corrosion protection, glass transition temperature is lower than EVA, formulations do not need additional layers (e.g. PET film) to pass IEC electrical insulation tests, and/or mechanical moduli do not vary as greatly as a function of temperature.

Base resins hereof include a copolymer of olefinic monomers. These monomers include one or more α-olefins which can include ethylene, propylene, octene, butene or any combination thereof. The olefins may also be metallocene catalyzed, typically for transparency. This can be a good way to get a low crystallinity material. An exemplary base resin may be a product, e.g., commercially available Dow Chemical Engage 8100 (ethylene-octene copolymer). Similarly the Dow Chemical Engage 8130 (ethylene-octene copolymer) has also been found acceptable. A composition hereof may thus include a base resin including one or more of one or more elements from the Dow Chemical Engage product line, or one or more elements from the Exxon Exact product line, or other commercially available product lines. Properties which may be desirable in the resin may include one or more of a melt mass flow index (ASTM D1238 190° C./2.16 kg) that is greater than about 1 g/10 min; a percent (%) crystallinity less than about 20%; a melting point in the range of between about 50° C. and about 80° C.; and a glass transition temperature of less than about −30° C., although temperatures of about −40° C. have also been found to provide good results, noting that higher temperatures also provide acceptable results. These criteria may be easily met using a variety of resins from several different manufacturers, particularly those resins including aliphatic metallocene catalyzed copolymers principally composed of ethylene and/or propylene. A composition according hereto may alternatively further include one or more non-alpha olefin homopolymers or co-polymers as well.

A good formula hereof, particularly for use in photovoltaics, may include about 2.5 parts per hundred of rubber (phr) lupersol TBEC (tertbutyl peroxy 2-ethyl-hexyl carbonate) as a peroxide curing agent. Luperox P (tertbutyl peroxy benzoate) and Lupersol 231 (1,1-ditertbutyl peroxy-2,2,4-trimethyl cyclohexane) were also found to work well. It appears that essentially any thermally activated radical producing cure agent, including but not limited to peroxy agents, that decomposes in the range of between about 100° C. and about 140° C. will work, though often may be between about 120° C. and about 140° C. This material may alternatively or additionally also be formulated to cure under UV light.

Light stabilization, particularly for outdoor use, (e.g., exposure to light such as sun light and/or Ultraviolet (UV) light) may be achieved through addition to the base resin of one or more light stabilizers which include generally, UV stabilizers and UV absorbers. UV stabilization may be accomplished using a hindered ammine light stabilizer (HALS) alone or along with a 2-hydroxyphenyl benzotriazole based UV absorber. Good UV stability has been found by using about 0.1 phr Tinuvin 770 [bis(2,2,6,6-tetramethyl-4-piperidinyl)sebacate], and about 0.6 phr Tinuvin 234 [2-(2H-benzzotriazol-2-yl)4,6-bis(1-ethyl-1-phenylethylphenol].

A further, and in some implementations, a primary component may be an adhesion promoting agent or adhesion promoter. Such can be based on trialkoxy silanes to provide a self-priming laminate adhesive film (note, self-priming generally means that no separate priming step is necessary to achieve good adhesion to a surface; noting still further that even so, self-priming does not foreclose the possibility that such a separate priming step may be performed). During testing, Dow Corning Z6030 (gama-methacroyloxy propyl trimethoxysilane) at about 1.5 phr along with BTESE [bis (triethoxy silyl)ethane] at about 0.5 phr was found to be effective. The addition of BTESE appears to provide a slightly improved adhesion but not enough to necessitate it being used in all formulations. However, DC Z6030 has outperformed other silanes tested. Good adhesion may also be achieved through the use of a separate primer step where primer is added directly to the surface to be adhered to. Other trialkoxy silanes may also prove to be acceptable.

These formulation details have been found to represent a good mixture for an olefinic composition having good adhesion and light stable characteristics. Even so, a larger set of chemicals were also tried and found to function. The HALS and the UV absorber are in particular easily substituted by other chemicals. The main consideration with such a substitution, particularly in photovoltaic use, is that it maintains good light transmission.

The principal reasons aliphatic polyolefins appear to not have been used in the past are that the low crystallinity/highly transmissive resins used here were not widely commercially available until the 1990s with the development of highly active metallocene catalysts. The other major impediment appears to have been that these materials are so non-polar that good adhesion is difficult. Thus, in the present developments it has been recognized that the use of a relatively large amount of silane coupling agent can produce a film with good adhesion along with some specific light stabilization formulation information.

### Example

The following example describes testing on small samples under accelerated weathering conditions. In this example, laminate films were made using a commercially available CW Brabender screw extruder. These were extruded at a thickness of about 0.5 mm and a width of about 10 cm. Polymer resin pellets and additives were all used as is from the manufacturer. Chemical additives were placed in a glass jar with the resin pellets and shaken to disperse/mix the materials prior to addition into the extruder hopper. The extruder had different temperature control zones along the length of the screw that were held at temperatures of 65° C., 85° C., 85° C., and 85° C. respectively.

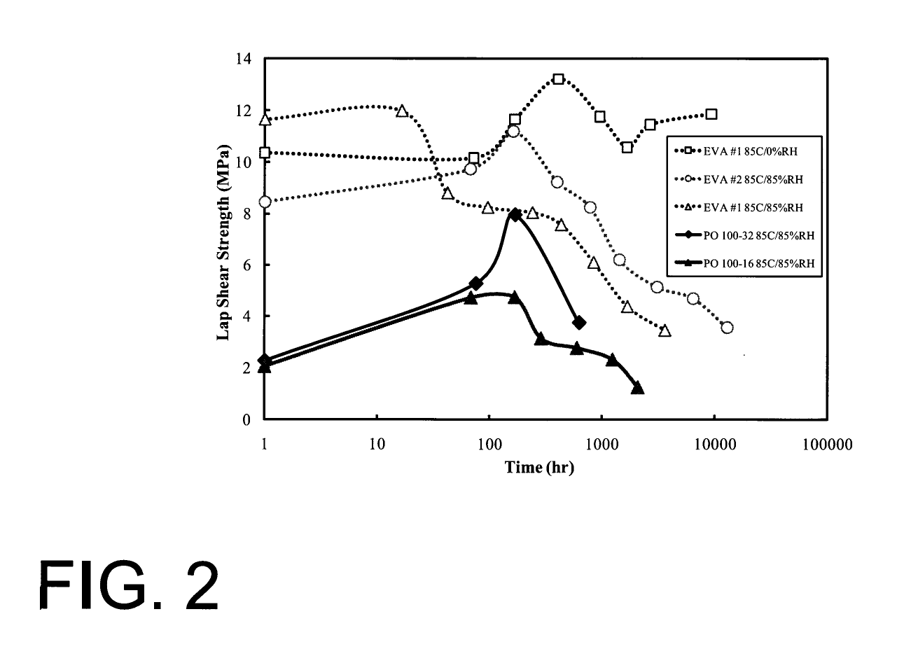

A large number of different formulations were tested as shown in Table 1. The amount of polymer resin was varied between about 89 wt % (weight percent) and about 98 wt % with typical ideal values between about 94 wt % and about 96 wt %. A UV absorber was found to be beneficial at up to about 1.2 wt % but with ideal values between about 0.4 wt % and about 0.6 wt %. Benzotrazole based UV absorbers were tried, but a wide variety of other classes of UV absorbers may also be used (such as those based on benzophenones). A hindered amine light stabilizer (HALS) was tested up to about 0.75 wt % with ideal values between about 0.05 and about 0.15 wt %. Excited state quenchers, such as Ciba® Tiongard® Q (Tris (tetramethylhydroxypiperidinol) citrate) may also be used. The use of phosphates, hindered phenols, or other reactive antioxidants may also prove beneficial. Up to about 9% trialkoxy silanes were used as adhesion promoters. However, it is doubtful that at 9% this much liquid was actually incorporated into the films. At amounts less than about 0.5 wt % good adhesion was not obtained (note, for some examples of relative adhesion; please see FIG. 2 and description relative thereto, below). Better results were obtained for formulas with between about 1.5 wt % to about 2.5 wt % silane. This range was found to promote good adhesion. Gama-methacroyloxy propyl trimethoxysilane was in particular found to promote good adhesion. A number of different peroxides at up to about 3.3 wt % were found to provide good adhesion. In particular TBEC (oo-Tertbutyl-o-2-ethyl-hexyl peroxycarbonate) was found to provide good adhesion at concentrations between about 2 and about 2.5 wt %. However, Lupersol 231 [1,1,5-trimethyl-3,3-bis(tert-butylperoxy)cyclohexane] cured more quickly at the same molar concentration. Note, in the following table, Table 1, the different samples were labeled 100-1; 130-1; 100-2; 100-3 and the like; with corresponding weight percents of the particular additives thereof.

TABLE 1
Formulation details.

| | | Name | | | | | | | | | | | |
|---|---|---|---|---|---|---|---|---|---|---|---|---|---|
| | | 100-1 | 130-1 | 100-2 | 100-3 | 100-4 | 130-2 | 130-3 | 130-4 | 100-5 | 130-5 | 100-6 | 100-7 |
| Ingredient | Comment | (g) | (g) | (g) | (g) | (g) | (g) | (g) | (g) | (g) | (g) | (g) | (g) |
| Dow Chemical Engage 8100 | Poly Ethylene Octene | 97.90 | | 97.90 | 97.85 | 97.90 | | | | 97.90 | | 97.90 | 96.85 |
| | Metallocene catalyzed | | | | | | | | | | | | |
| Dow Chemical Engage 8130 | Poly Ethylene Octene | | 97.90 | | | | 97.90 | 97.85 | 97.90 | | 97.90 | | |
| | Metallocene catalyzed | | | | | | | | | | | | |
| Tinuvin 234 | 2-(2H-benzzotriazol-2- | 0.29 | 0.29 | 0.29 | 0.29 | 0.29 | 0.29 | 0.29 | 0.29 | 0.29 | 0.29 | 0.29 | 0.29 |
| | yl)4,6-bis(1-ethyl-1- | | | | | | | | | | | | |
| | phenylethylphenol | | | | | | | | | | | | |
| Tinuvin 770 | bis(2,2,6,6-tetramethyl-4- | 0.10 | 0.10 | 0.10 | 0.10 | 0.10 | 0.10 | 0.10 | 0.10 | 0.10 | 0.10 | 0.10 | 0.10 |
| | piperidinyl)sebacate | | | | | | | | | | | | |
| Dow Corning Z6030 | gama-methacroyloxy | 0.24 | 0.24 | 0.24 | 0.24 | | 0.24 | 0.24 | | 0.24 | 0.24 | 0.24 | 1.31 |
| | propyl trimethoxysilane | | | | | | | | | | | | |
| BTESE | Bis(TriEthoxy Silyl) Ethane | | | | 0.05 | | | 0.05 | | | | | |
| Dow Corning Z6300 | Vinly Trimethoxy silane | | | | | 0.24 | | | 0.24 | | | | |
| TBEC | oo-Tertbutyl-o-2-ethyl- | 1.47 | 1.47 | 1.47 | 1.47 | 1.47 | 1.47 | 1.47 | 1.47 | 1.47 | 1.47 | 1.47 | 1.45 |
| | hexyl peroxycarbonate, | | | | | | | | | | | | |
| Lupersol 101 | 2,5-bis(tert-butylperoxy)- | | | | | | | | | | | | |
| | 2,5-dimethylhexane | | | | | | | | | | | | |
| Luperox P | tert butyl peroxybenzoate | | | | | | | | | | | | |
| Lupersol 231 | 1,1,5-trimethyl-3,3-bis(tert- | | | | | | | | | | | | |
| | butylperoxy)cyclohexane | | | | | | | | | | | | |

| | | Name | | | | | | | | |
|---|---|---|---|---|---|---|---|---|---|---|
| | | 100-8 | 100-9 | 100-10 | 100-11 | 100-12 | 100-13 | 100-14 | 100-15 | 100-16 |
| Ingredient | Comment | (g) | (g) | (g) | (g) | (g) | (g) | (g) | (g) | (g) |
| Dow Chemical Engage 8100 | Poly Ethylene Octene | 95.79 | 95.60 | 93.37 | 89.37 | 96.25 | 95.33 | 94.43 | 97.18 | 96.25 |
| | Metallocene catalyzed | | | | | | | | | |
| Dow Chemical Engage 8130 | Poly Ethylene Octene | | | | | | | | | |
| | Metallocene catalyzed | | | | | | | | | |
| Tinuvin 234 | 2-(2H-benzzotriazol-2- | 0.29 | 0.29 | 0.28 | 0.27 | 0.29 | 0.29 | 0.28 | 0.29 | 0.29 |
| | yl)4,6-bis(1-ethyl-1- | | | | | | | | | |
| | phenylethylphenol | | | | | | | | | |
| Tinuvin 770 | bis(2,2,6,6-tetramethyl-4- | 0.10 | 0.10 | 0.09 | 0.09 | 0.10 | 0.10 | 0.09 | 0.10 | 0.10 |
| | piperidinyl)sebacate | | | | | | | | | |
| Dow Corning Z6030 | gama-methacroyloxy | 2.39 | 2.58 | 4.86 | 8.94 | 1.92 | 2.86 | 3.78 | 0.97 | 1.92 |
| | propyl trimethoxysilane | | | | | | | | | |
| BTESE | Bis(TriEthoxy Silyl) Ethane | | | | | | | | | |
| Dow Corning Z6300 | Vinly Trimethoxy silane | | | | | | | | | |
| TBEC | oo-Tertbutyl-o-2-ethyl- | 1.44 | 1.43 | 1.40 | 1.34 | 1.44 | 1.43 | 1.42 | 1.46 | 1.44 |
| | hexyl peroxycarbonate, | | | | | | | | | |
| Lupersol 101 | 2,5-bis(tert-butylperoxy)- | | | | | | | | | |
| | 2,5-dimethylhexane | | | | | | | | | |
| Luperox P | tert butyl peroxybenzoate | | | | | | | | | |
| Lupersol 231 | 1,1,5-trimethyl-3,3-bis(tert- | | | | | | | | | |
| | butylperoxy)cyclohexane | | | | | | | | | |

| | | Name | | | | | | | |
|---|---|---|---|---|---|---|---|---|---|
| | | 100-17 | 100-18 | 100-19 | 100-20 | 100-21 | 100-22 | 100-23 | 100-24 |
| Ingredient | Comment | (g) | (g) | (g) | (g) | (g) | (g) | (g) | (g) |
| Dow Chemical Engage 8100 | Poly Ethylene Octene | 95.33 | 94.43 | 96.25 | 96.43 | 94.97 | 95.24 | 94.61 | 93.81 |
| | Metallocene catalyzed | | | | | | | | |
| Dow Chemical Engage 8130 | Poly Ethylene Octene | | | | | | | | |
| | Metallocene catalyzed | | | | | | | | |
| Tinuvin 234 | 2-(2H-benzzotriazol-2- | 0.29 | 0.28 | 0.29 | 0.58 | 1.14 | 0.29 | 0.28 | 0.28 |
| | yl)4,6-bis(1-ethyl-1- | | | | | | | | |
| | phenylethylphenol | | | | | | | | |
| Tinuvin 770 | bis(2,2,6,6-tetramethyl-4- | 0.10 | 0.09 | 0.10 | 0.10 | 0.09 | 0.19 | 0.38 | 0.75 |
| | piperidinyl)sebacate | | | | | | | | |
| Dow Corning Z6030 | gama-methacroyloxy | 2.86 | 3.78 | 1.92 | 1.45 | 0.95 | 0.48 | 1.42 | 0.94 |
| | propyl trimethoxysilane | | | | | | | | |
| BTESE | Bis(TriEthoxy Silyl) Ethane | | | | 0.48 | 0.95 | 1.43 | 0.47 | 0.94 |
| Dow Corning Z6300 | Vinly Trimethoxy silane | | | | | | | | |
| TBEC | oo-Tertbutyl-o-2-ethyl- | 1.43 | 1.42 | 1.44 | 0.96 | 1.90 | 2.38 | 2.84 | 3.28 |
| | hexyl peroxycarbonate, | | | | | | | | |
| Lupersol 101 | 2,5-bis(tert-butylperoxy)- | | | | | | | | |
| | 2,5-dimethylhexane | | | | | | | | |
| Luperox P | tert butyl peroxybenzoate | | | | | | | | |
| Lupersol 231 | 1,1,5-trimethyl-3,3-bis(tert- | | | | | | | | |
| | butylperoxy)cyclohexane | | | | | | | | |

| | | Name | | | | | | | |
|---|---|---|---|---|---|---|---|---|---|
| | | 100-25 | 100-26 | 100-27 | 100-28 | 100-29 | 100-30 | 100-31 | 100-32 |
| Ingredient | Comment | (g) | (g) | (g) | (g) | (g) | (g) | (g) | (g) |
| Dow Chemical Engage 8100 | Poly Ethylene Octene | 95.06 | 95.06 | 95.06 | 95.06 | 94.60 | 95.48 | 94.49 | 95.00 |
| | Metallocene catalyzed | | | | | | | | |
| Dow Chemical Engage 8130 | Poly Ethylene Octene | | | | | | | | |
| | Metallocene catalyzed | | | | | | | | |
| Tinuvin 234 | 2-(2H-benzzotriazol-2- | 0.57 | 0.57 | 0.57 | 0.57 | 0.57 | 0.57 | 0.57 | 0.57 |
| | yl)4,6-bis(1-ethyl-1- | | | | | | | | |
| | phenylethylphenol | | | | | | | | |
| Tinuvin 770 | bis(2,2,6,6-tetramethyl-4- | 0.10 | 0.10 | 0.10 | 0.10 | 0.09 | 0.10 | 0.09 | 0.10 |
| | piperidinyl)sebacate | | | | | | | | |
| Dow Corning Z6030 | gama-methacroyloxy | 0.95 | 1.43 | 0.48 | 1.90 | 1.42 | 1.43 | 1.42 | 1.43 |
| | propyl trimethoxysilane | | | | | | | | |
| BTESE | Bis(TriEthoxy Silyl) Ethane | 0.95 | 0.48 | 1.43 | | 0.53 | 0.53 | 0.53 | 0.53 |
| Dow Corning Z6300 | Vinly Trimethoxy silane | | | | | | | | |
| TBEC | oo-Tertbutyl-o-2-ethyl- | 2.38 | 2.38 | 2.38 | 2.38 | | | | 2.38 |
| | hexyl peroxycarbonate, | | | | | | | | |
| Lupersol 101 | 2,5-bis(tert-butylperoxy)- | | | | | 2.79 | | | |
| | 2,5-dimethylhexane | | | | | | | | |
| Luperox P | tert butyl peroxybenzoate | | | | | | 1.88 | | |
| Lupersol 231 | 1,1,5-trimethyl-3,3-bis(tert- | | | | | | | 2.90 | |
| | butylperoxy)cyclohexane | | | | | | | | |

The base resins in the Table 1 formulations are, as shown, either Dow Chemical Engage 8100 or Dow Engage 8130. The Tinuvan 234 is a UV absorber. The Tinuvin 770 is a hindered amine light stabilizer. The Dow Corning Z6030, Dow Corning Z6300 and BTESE are adhesion promoters. Other adhesion promoters are the peroxide cures or cross-linkers of TBEC, Lupersol 101, Luperox P, and Lupersol 231.

In this example, cured films were exposed to about 60° C. and about 60% RH (relative humidity) with about 114 W/m² over the wavelength range of 300 to 400 nm (approximately 2.5 AM 1.5 UV suns). These samples were exposed without the use of a glass cover that may typically block most of the UV radiation. After about 3521 h of UV exposure, the samples had not noticeably yellowed. This amount of time produces a UV dose roughly equal to about 14 years of outdoor exposure behind cerium doped low iron glass.

Moisture diffusivity and solubility measurements were made and the films were found to have a diffusivity that was about 4 to 5 times higher but a solubility that is about 20 times lower than EVA. A higher diffusivity means it will equilibrate faster but the lower solubility indicates less overall moisture will penetrate a module. The lower solubility also indicates the polymer is significantly less polar, and makes it more difficult for corrosion by-products to diffuse, thereby slowing down module degradation.

Measurement of the mechanical moduli indicates glass transition is in the range of about −40° C. to about −50° C. as compared with −15° C. to −27° C. for EVA. This is advantageous because this allows the polyolefin encapsulants to mechanically protect module components over a lower and a wider temperature range.

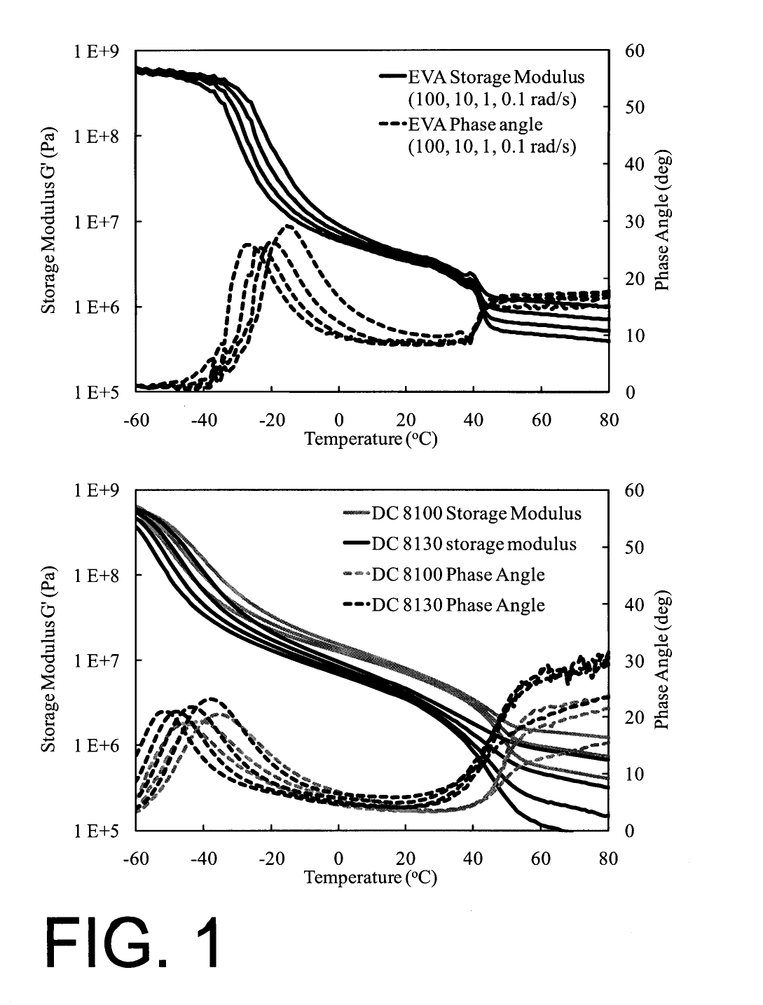

FIG. 1 shows the storage modulus and phase angle of EVA as compared with some sample alpha-polyolefins hereof. Dynamic mechanical analysis of a commercial EVA formulation and from an unformulated polyolefin material. Each set of data contains measurements made at 100, 10, 1, and 0.1 rad/s and 0.5% strain.

The use of metallocene catalysts enables very good control over the melting point of these polyolefins. By changing the ratios and types of monomers, or by changing the catalyst, a wide range of flow properties can be achieved enabling better control over processing conditions as compared to standard EVAs used in the PV industry.

In this example, lap shear samples to glass were found to provide sufficient adhesive properties to enable the film to pass the “damp heat” test of the PV module qualification test (IEC 61215 and IEC 61646). In FIG. 2, which is a depiction of a comparison of lap shear results after exposure to 85° C./85% RH or 85° C./0% RH, the adhesion of the polyolefin formulation initially improves. This is due to some chemical reactions between the adhesion promoter and the glass surfaces. After 1000 hr of damp heat (85° C./85% RH) the polymer is still adhered indicating it is adequate to pass the PV qualification tests.

The Wet High Pot Test is part of IEC 61215 (which is a standard for photovoltaic modules). The standard specifies that after 1000 hr of exposure to 85 C/85% RH photovoltaic modules are immersed in a surfactant containing bath with an applied voltage of 500V and the measured resistance to the bath are greater than 40 MW·m² for photovoltaic modules>0.1 m². To do this test, 5 inch square steel plates were laminated and tested to model a cell. Resistance are greater than 2.48 GΩ to pass. All samples used EVA between the Steel and a piece of glass while the back-sheet was varied. Steel sheet is 0.85 mm or 0.64 mm, Glass is 2.26 mm, EVA has a nominal 0.46 mm thickness per sheet. “Failed” indicates the ohm meter may not reach 500 V because of high current. >10 GΩ indicates the current was too low to measure with the test equipment used.

A module encapsulated with EVA only (i.e., no back-sheet included) will not pass the wet high pot test. Polyolefin films hereof, however, will pass the wet high pot test after about 1000 h of about 85° C./85% RH without the need for a back-sheet. A comparison is shown in Table 2, below; PO 100-1 representing the polyolefin sample 100-1 set forth above.

TABLE 2

| | Back-sheet | Total | | | | | | | |
|---|---|---|---|---|---|---|---|---|---|
| Back-Sheet | Thickness | Thickness | Time | | | Time | | Time | |
| Construction | (mm) | (mm) | (hr) | Resistance | | (hr) | Resistance | (hr) | Resistance |
| EVA | 0.5 mm | 4.07 | 0 | 1 | MΩ | 504 | Failed | 1032 | Failed |
| EVA/TPE | 0.69 | 4.26 | 0 | 6.6 | GΩ | 504 | 8.5 GΩ | 1032 | 9.1 GΩ |
| PO 100-1 | 0.435 mm | 3.77 | 0 | 7.81 | GΩ | 192 | 7.4 GΩ | 2176 | 8.76 GΩ |

As noted, present formulations hereof may prove advantageous over EVA because the present formulations do not produce acetic acid as a by-product, they are less polar than EVA creating better corrosion protection, their glass transition temperature is lower than EVA, they do not need additional layers (e.g. PET film) to pass IEC electrical insulation tests, and their mechanical moduli do not vary as greatly as a function of temperature. Even so, it may be that it also takes some time for the adhesion chemistry of the present films to set. Moreover, the present films may transmit about 0.5% less light than EVA, and an estimated present cost may be at most about $0.5 to about $0.75 more per m² (square meter) assuming the processing conditions remain similar to those currently for EVA. Nevertheless, such may very well be offset by the better long term performance hereof and in particular the cost and transmission issues may be overcome by choosing different resins or by creating mixtures of resins.

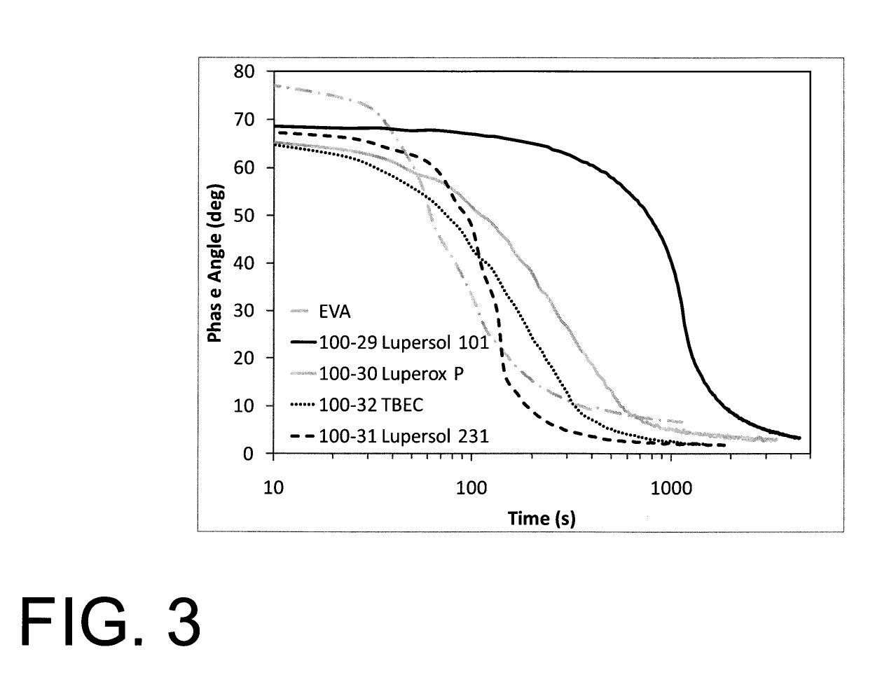

For sample formulations 100-29 through 100-32, the same base composition was used while varying the type of peroxide used (Table 1). The wt % peroxide was varied slightly such that the mols of peroxide was maintained substantially constant for each formulation. Dynamic mechanical analysis was performed on these samples in a TA instruments ARES rheometer. The rheometer was heated up to 145° C. then the samples were quickly loaded (−5 seconds) and measurements of the phase angle were made at 1 rad/s and 0.5% strain. When the phase angle reaches 45° the material is said to have reached its gel point, but sufficient cure to prevent flow is not present until the phase angle is around 15° to 25°. Also shown for comparison is an EVA sample which cured in about the same amount of time. Peroxides are often characterized by a 1 h T_{1/2} temperature at which half of the peroxide will decompose in 1 h. The T_{1/2} for Luperox 101, Luperox P, TBEC, and Lupersol 231 are 140, 125, 121, and 115° C. respectively. In FIG. 3 one can see a strong correlation with T_{1/2} and the time to cure. In FIG. 3, the phase angle is measured using dynamic mechanical analysis at cel rad/s at 145° C. Each sample used a different peroxide as indicated. EVA is a commercially available material. Sample 100-29, 100-30, 100-31, 100-32 had 2.8, 1.9, 2.9, 2.4 wt % peroxide respectively. TBEC is OO-Tertbutyl-O-2-ethyl-hexyl peroxycarbonate, 0.133 kPa at 20 C. Lupersol 101 is 2,5-bis(tert-butylperoxy)-2,5-dimethylhexane. Luperox P is tert butyl peroxybenzoate. And Lupersol 231 is 1,1,5-trimethyl-3,3-bis(tert-butylperoxy)cyclohexane.

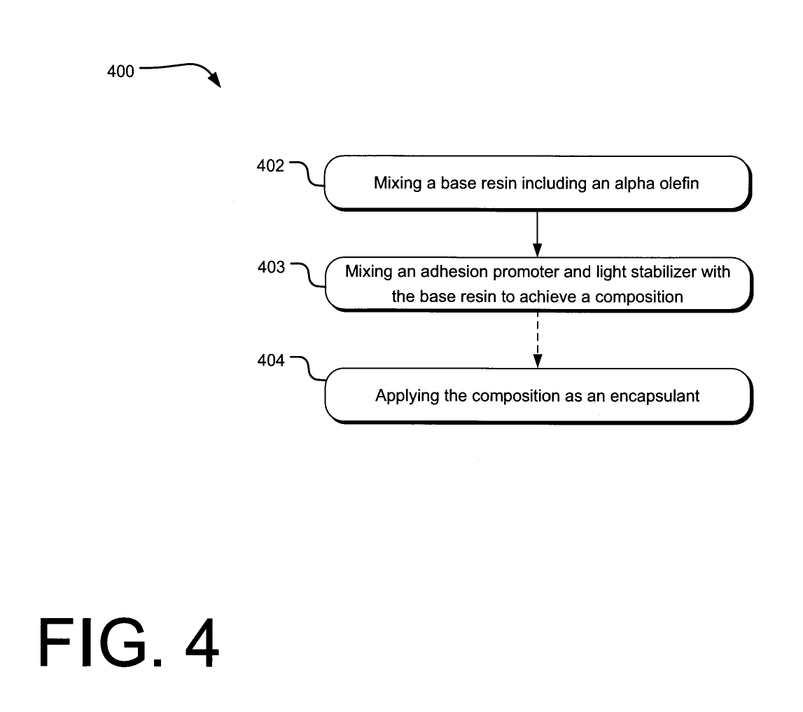

A flowchart depiction of a method for making compositions hereof is shown in FIG. 4. A method 400 for making a composition may include at least mixing a base resin; operation 402, and mixing; operation 403, with a base resin an adhesion promoter and a light stabilizer. In an optional additional operation 404 (shown as optional by the dashed line) may include the applying the composition as an encapsulant to a photovoltaic cell to make a photovoltaic cell.

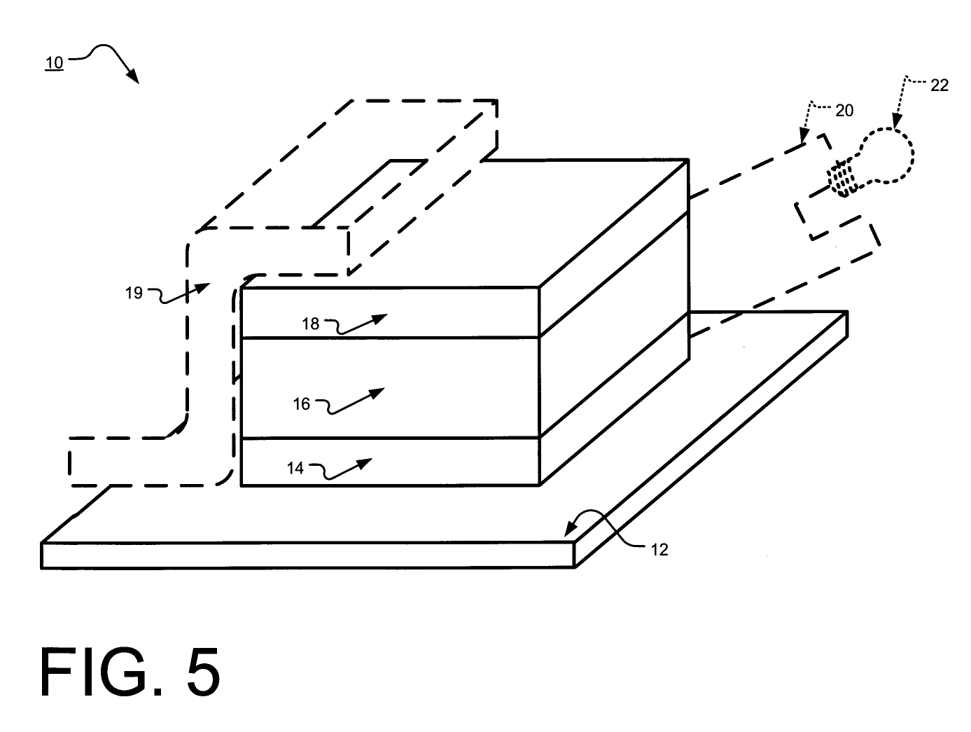

A sample device 10, e.g., a photovoltaic cell 10 made using a composition hereof is shown in FIG. 5. On a substrate 12 is a combination of electrodes 14, 18 having a dielectric 16 therebetween. The encapsulant 19 is disposed thereover (shown only partially covering the electrodes, in dashed lines). The electrodes are shown schematically as they might be connected 20 to a load 22.

While a number of exemplary aspects and embodiments have been discussed above, those of skill in the art will recognize certain modifications, permutations, additions and sub combinations thereof. It is therefore intended that the following appended claims and claims hereafter introduced are interpreted to include all such modifications, permutations, additions and sub-combinations as are within their true spirit and scope.

What is claimed is:

1. A composition comprising:
a base resin including a copolymer including at least one or more α-olefins;
one or more light stabilizers; and,
one or more adhesion promoters.

2. A composition according to claim 1 wherein the α-olefins are one or more of ethylene, propylene, octene, or butene.

3. A composition according to claim 1 wherein one or more of the α-olefins are polymerized using a metallocene-based catalyst.

4. A composition according to claim 1 further including one or more non-alpha olefin homopolymers or co-polymers.

5. A composition according to claim 1 wherein:
the base resin is between about 89 wt % and about 98 wt % of the composition;
the light stabilizer is between about 0.05 wt % and about 1.95 wt %; and,
the adhesion promoter is between about 0.5 and about 9%.

6. A composition according to claim 1 wherein one or more of the following:
the base resin is between about 94 wt % and about 96 wt % of the composition;
the light stabilizer is between about 1.25 wt % and about 1.35 wt %; and,
the adhesion promoter is between about 1.5 and about 2.5%.

7. A composition according to claim 1 wherein
the light stabilizer includes a UV absorber between about 0.05 wt % and about 1.2 wt %;
and, a hindered amine light stabilizer between about 0.05 wt % and about 0.75 wt %.

8. A composition according to claim 1 wherein the base resin includes one or more of the following properties:
a melt mass flow index (ASTM D1238 190° C./2.16 kg) that is greater than about 1 g/10 min at about 190° C.;
a percent (%) crystallinity less than about 20%;
a melting point in the range of between about 50° and about 80° C.; and
a glass transition temperature less than about −30° C.

9. A composition according to claim 1 wherein the base resin includes one or more of one or more elements from the Dow Chemical Engage product line, or one or more elements from the Exxon Exact product line.

10. A composition according to claim 1 wherein the base resin includes one or more of Dow Chemical Engage 8100 and Dow Chemical Engage 8130.

11. A composition according to claim 1 further including a peroxide curing agent.

12. A composition according to claim 11 wherein the peroxide curing agent decomposes in the range of between about 100° C. and about 140° C.

13. A composition according to claim 11 wherein the peroxide curing agent includes one or more of lupersol TBEC (tertbutyl peroxy 2-ethyl-hexyl carbonate); Luperox P (tertbutyl peroxy benzonate) and Lupersol 231 (1,1-ditertbutyl peroxy-2,2,4-trimethyl cyclohexane).

14. A composition according to claim 11 wherein the peroxide curing agent is present at about 2.5 phr.

15. A composition according to claim 1 wherein the one or more light stabilizers includes one or more of a UV stabilizer, a hindered ammine light stabilizer and a UV absorber.

16. A composition according to claim 15 wherein the UV absorber is a 2-hydroxyphenyl benzotriazole based UV absorber.

17. A composition according to claim 1 wherein the one or more adhesion promoters include one or more trialkoxy silanes.

18. A composition according to claim 17 wherein the one or more trialkoxy silanes include one or both of gama-methacroyloxy propyl trimethoxysilane and bis (triethoxy silyl)ethane.

19. A composition according to claim 18 wherein one or both of respective phr's of the gama-methacroyloxy propyl trimethoxysilane and the bis (triethoxy silyl)ethane are:
for the gama-methacroyloxy propyl trimethoxysilane, the phr is at about 1.5 phr; and,
for the bis (triethoxy silyl)ethane the phr is at about 0.5 phr.

20. A composition according to claim 1 applied in one or more of a photovoltaic cell or module, or used in a process for converting electromagnetic energy to electricity in a photovoltaic process.

21. A photovoltaic cell including an encapsulant composition comprising:
a base resin including a copolymer of one or more alpha-olefins,
one or more light stabilizers, and,
one or more adhesion promoters.

22. A photovoltaic cell as in claim 21 where the one or more alpha-olefins include one or more of ethylene, propylene, octene, butene, any one or more of which being metallocene catalyzed.

23. A method for making a photovoltaic cell including at least:
mixing a polyolefin-based encapsulant composition comprising:
a base resin including a copolymer including one or more alpha-olefins; one or more light stabilizers; and, one or more adhesion promoters, and,
applying the encapsulant composition to a photovoltaic cell.

24. A method according to claim 23 wherein the alpha-olefins are one or more of metallocene catalyzed ethylene, propylene, octene, or butene.

25. A method for using a photovoltaic cell including a polyolefin-based encapsulant composition including a base resin of a metallocene catalyzed copolymer of ethylene, propylene, and either or both octene or butene; the method comprising passing light through the encapsulant for use by the photovoltaic cell.
